(19) United States
(12) Patent Application Publication
(10) Pub. No.: US 2008/0113184 A1
(43) Pub. Date: May 15, 2008

(54) ADHESIVE SHEET

(75) Inventors: Shinichiro YOSHIDA, Kamisu-shi (JP); Masahiro Usuki, Kamisu-shi (JP); Tadashi Amano, Kamisu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/939,973

(22) Filed: Nov. 14, 2007

(30) Foreign Application Priority Data
Nov. 15, 2006 (JP) 2006-309180

(51) Int. Cl. B32B 7/12

(52) U.S. Cl. 428/332

(57) ABSTRACT

An adhesive sheet including a releasable base material, and an adhesive layer formed on one surface of the base material is provided. The adhesive layer includes an adhesive composition including (A) 100 parts by mass of a carboxyl group-containing urethane-modified polyester resin, (B) an epoxy resin, (C) a curing agent, and (D) an inorganic filler, and has a thickness within a range from 40 to 100 μm. The adhesive sheet has a high degree of adhesiveness and excellent anti-migration properties, and is also effective as an interlayer insulating material.

### BACKGROUND OF THE INVENTION

1. Field of the Invention

The present invention relates to an adhesive sheet having an adhesive layer that yields a cured product, upon curing, that exhibits excellent adhesion and anti-migration properties, and relates particularly to an adhesive sheet that is useful as an interlayer insulating material for bonding the copper wiring surfaces of a pair of flexible printed circuit boards (hereafter abbreviated as FPC(s)).

2. Description of the Prior Art

In recent years, developments within the electronics field have been remarkable, and in particular, communication and consumer electronic devices have seen considerable progress in terms of device miniaturization, weight reduction, and increased component density, and demand for this type of improved performance continues to grow. In response to these demands, flexible printed circuit boards FPCs exhibit favorable flexibility and are resistant to repeated bending, meaning they can be packaged three dimensionally at a high density within a confined space, and they are consequently being used more and more widely as composite components that include functions such as the wiring, cabling or connectors to electronic equipment.

A coverlay film used in an FPC is prepared by applying a semi-cured adhesive to at least one surface of an electrically insulating base film, and then usually bonding a protective release sheet to the applied layer of the adhesive. The release sheet is peeled off prior to use, and the exposed adhesive layer is then bonded to the FPC for purposes such as (1) protecting the circuits of, and (2) improving the flexibility of, the FPC. The properties required of a coverlay film include favorable adhesion, heat resistance, electrical properties, storage properties, workability and handling properties.

An adhesive sheet used in an FPC comprises a semi-cured adhesive layer provided on one surface of a releasable base material. These adhesive sheets are used as the adhesive material in situations such as the production of a multilayer FPC by bonding together a plurality of FPCs that have each been prepared by pressure bonding of a coverlay film, and the bonding together of an FPC and a reinforcing sheet. Moreover, uses as an insulating material for copper wiring, a role that has conventionally been performed by coverlay films, or as an interlayer insulating material for bonding the copper wiring surfaces of another pair of FPCs are also being investigated. However, in order to be usable for bonding copper wiring surfaces together, an adhesive sheet requires similar anti-migration properties to a coverlay film, and in order to ensure that short circuits do not occur between the bonded copper wiring surfaces, a thickness of at least 40 μm is required for the adhesive layer. The properties required of an adhesive sheet include favorable adhesion, heat resistance, electrical properties, storage properties, workability and handling properties.

Recently, multilayering and increasingly fine patterning of FPCs has continued to progress, and the environments in which FPCs are used are of increasingly higher temperatures and humidity, meaning the properties required for FPCs continue to become more demanding. Under these circumstances, the electrical insulation between the wiring is an important factor in determining the reliability of the FPC, meaning demands for improved anti-migration properties are growing. The anti-migration properties are more strongly affected by the adhesive of the coverlay film or the adhesive of the adhesive sheet than by the flexible printed circuit board, and tend to be inferior for multilayer FPCs compared with single layer FPCs. As a result, favorable anti-migration properties are now being demanded for the adhesive of the coverlay film or the adhesive of the adhesive sheet within a multilayered FPC.

In order to address these demands, most of the technology proposed for coverlay films and adhesive sheets relates to (1) the use of resins with a low ion content, (2) the use of additives such as ion adsorbents, and (3) the use of resins with favorable migration properties. For example, systems that contained an added ion adsorbent (patent reference 1), systems that use a resin with favorable migration properties (patent references 2 and 3), systems that use a phosphorus-based flame retardant with favorable migration properties (patent references 4, 5 and 6), systems that use a resin with a low ion content (patent reference 7), and systems that use a urethane-modified polyester resin (patent reference 8) have been proposed. However, in all of these proposals, the adhesive is used as a coverlay film, and the migration properties are not entirely satisfactory upon multilayering of FPCs or lamination to rigid sheets. Moreover, when attempts were made to use this conventional technology to produce an adhesive sheet having an adhesive layer with the thickness required for use as an interlayer insulating material, large quantities of bubbles were incorporated within the adhesive layer, meaning the production of a thick-film adhesive sheet having a uniform and defect-free adhesive layer with a thickness of at least 40 μm was impossible.

[Patent Reference 1] JP 2005-015553A

[Patent Reference 2] JP 2002-080812A

[Patent Reference 3] JP 08-283535A

[Patent Reference 4] JP 2005-015595A

[Patent Reference 5] JP 2002-060720A

[Patent Reference 6] JP 2005-053989A

[Patent Reference 7] JP 2003-165898A

[Patent Reference 8] U.S. Pat. No. 6,194,523

### SUMMARY OF THE INVENTION

Accordingly, an object of the present invention is to provide an adhesive sheet having an adhesive layer with a thickness of 40 to 100 μm, which has a high degree of adhesiveness and excellent anti-migration properties, and is also effective as an interlayer insulating material.

In order to achieve the above object, the present invention provides an adhesive sheet comprising a releasable base material, and an adhesive layer formed on one surface of the base material, wherein the adhesive layer comprises an adhesive composition comprising:

### (A) 100 parts by mass of a carboxyl group-containing urethane-modified polyester resin,

### (B) 5 to 100 parts by mass of an epoxy resin,

### (C) 0.1 to 30 parts by mass of a curing agent, and

### (D) 10 to 60 parts by mass of an inorganic filler per 100 parts by mass of the combination of components (A) through (C),

and has a thickness within a range from 40 to 100 μm.

The composition used in the present invention yields a cured product, upon curing, that exhibits excellent adhesion and anti-migration properties, and consequently an adhesive sheet prepared using this composition also exhibits excellent adhesion and anti-migration properties. Moreover, because the adhesive layer has a uniform and defect-free thickness of 40 to 100 μm, it is useful in forming a highly functional adhesive layer for use as an interlayer insulating material.

### DETAILED DESCRIPTION OF THE PREFERRED EMBODIMENTS

A more detailed description of the present invention is presented below. In this specification, the term “number average molecular weight” refers to a number average molecular weight measured using gel permeation chromatography and referenced against polystyrene standards.

### <Adhesive Composition>

The adhesive composition used in the present invention comprises the components (A) through (D) described above, and if required, may also include other optional components such as a solvent.

First is a description of the adhesive composition used in the present invention. First, the components (A) to (D) that represent the composition constituents are described below in sequence.

### [(A) Carboxyl Group-Containing Urethane-Modified Polyester Resin]

The carboxyl group-containing urethane-modified polyester resin of the component (A) is obtained by reacting a carboxyl group-containing polyester resin and an organic diisocyanate. The carboxyl group-containing polyester resin used in this reaction can be synthesized by known methods, by first synthesizing a polyester resin by a dehydration/esterification reaction between an acid component and a polyol component in the presence of a catalyst, and subsequently adding an acid anhydride.

Examples of the polyol used in the above reaction include ethylene glycol, diethylene glycol, propylene glycol, dipropylene glycol, neopentyl glycol, trimethylol glycol, butanediol, pentaerythritol, ethylene oxide adducts of bisphenol A, and propylene oxide adducts of bisphenol A.

Examples of the acid component include polybasic carboxylic acids such as terephthalic acid, isophthalic acid, adipic acid, maleic acid, fumaric acid, trimellitic acid, pyromellitic acid, and acid anhydrides of these acids.

Examples of the organic diisocyanate component include 1,6-hexamethylene diisocyanate, 2,4-tolylene diisocyanate, p-phenylene diisocyanate, diphenylmethane diisocyanate, hexamethylene diisocyanate, tetramethylene diisocyanate, and 1,5-naphthalene diisocyanate.

The number average molecular weight of the carboxyl group-containing urethane-modified polyester resin of the component (A) is typically within a range from 8,000 to 40,000, and is preferably from 10,000 to 20,000. If the number average molecular weight is smaller than 8,000, then the peel strength and solder heat resistance of the cured product of the resulting adhesive composition tend to deteriorate. Furthermore, if the number average molecular weight is larger than 40,000, then the viscosity upon dispersion of the adhesive composition within an organic solvent is very high, making the uniform and stable application of the resulting adhesive dispersion to the base material difficult, so that even if an attempt is made to produce an adhesive sheet having a thick-film adhesive layer, obtaining an adhesive sheet having an adhesive layer with a uniform and defect-free thickness of at least 40 μm is problematic.

The quantity of carboxyl groups contained within the carboxyl group-containing urethane-modified polyester resin is preferably within a range from 0.4 to 8.0% by mass, even more preferably from 1.0 to 6.0% by mass, and is most preferably from 1.0 to 4.0% by mass. If this quantity is too small, then the number of cross-linking points is reduced, meaning the solder heat resistance and solvent resistance of the resin tend to deteriorate, whereas if the quantity is too large, the storage properties of the adhesive deteriorate markedly.

The carboxyl group-containing urethane-modified polyester resin of the component (A) may use either a single resin, or if necessary, a combination of two or more different resins.

### [(B) Epoxy Resin]

The epoxy resin of the component (B) preferably contains two or more, and particularly three or more, epoxy groups within each molecule, but there are no particular restrictions on other aspects of the resin, which may be modified with a silicone, urethane, polyimide or polyamide or the like. Furthermore, a brominated epoxy resin may also be used to impart flame retardancy. Moreover, the resin skeleton may also incorporate phosphorus atoms, sulfur atoms, or nitrogen atoms or the like.

Specifically, examples of epoxy resins containing two epoxy groups within each molecule include bisphenol A epoxy resins, bisphenol F epoxy resins, stilbene epoxy resins, biphenyl epoxy resins, alicyclic epoxy resins and phenoxy resins. Examples of commercially available products include non-brominated epoxy resins such as the products Epikote 828, 871, 1001 and 1256 (manufactured by Japan Epoxy Resins Co., Ltd.) and Sumiepoxy ELA 115 and 127 (manufactured by Sumitomo Chemical Co., Ltd.), and brominated epoxy resins such as the products Epikote 5050, 5048 and 5046 (manufactured by Japan Epoxy Resins Co., Ltd.).

Examples of epoxy resins containing three or more epoxy groups within each molecule include phenol novolak epoxy resins, cresol novolak epoxy resins, glycidylamine epoxy resins, and polyphenylmethane epoxy resins. Examples of commercially available products include non-brominated epoxy resins such as the products Epikote 604 (manufactured by Japan Epoxy Resins Co., Ltd.), Sumiepoxy ESCN195X and ELM120 (manufactured by Sumitomo Chemical Co., Ltd.) and EOCN103S and EPPN502H (manufactured by Nippon Kayaku Co., Ltd.), and brominated epoxy resins such as the product BREN-S (manufactured by Nippon Kayaku Co., Ltd.).

Epoxy resins containing two epoxy groups within each molecule are effective in improving the flexibility and peel strength, whereas epoxy resins containing three or more epoxy groups within each molecule are effective in improving the heat resistance and the glass transition point of the cured adhesive. These features should be considered in selecting the resin to use, and either a single resin may be used alone, or two or more different resins may be combined.

The blend quantity of the component (B) is typically within a range from 5 to 100 parts by mass, preferably from 10 to 80 parts by mass, and even more preferably from 15 to 60 parts by mass, per 100 parts by mass of the component (A). If this blend quantity is less than 5 parts by mass, then the number of cross-linking points in the cured adhesive is reduced, meaning the solvent resistance and solder properties tend to deteriorate, whereas if the quantity exceeds 100 parts by mass, the peel strength deteriorates.

### [(C) Curing Agent]

The curing agent of the component (C) can use any of the materials typically used as epoxy resin curing agents. Examples of these curing agents include aliphatic amine-based curing agents such as diethylenetriamine, tetraethylenetetramine and tetraethylenepentamine, alicyclic amine-based curing agents such as isophorone diamine, aromatic amine-based curing agents such as diaminodiphenylmethane, diaminodiphenylsulfone and phenylenediamine, acid anhydride-based curing agents such as phthalic anhydride, pyromellitic anhydride, trimellitic anhydride and hexahydrophthalic anhydride, imidazole compounds such as 2-methylimidazole, 2-ethyl-4-methylimidazole and 1-cyanoethyl-2-ethyl-4-methylimidazole, dicyandiamide, borofluorides such as boron trifluoride amine complexes, tin borofluoride and zinc borofluoride, and octoate salts such as tin octoate and zinc octoate. Preferred curing agents include aliphatic amine-based curing agents, aromatic amine-based curing agents, imidazole compounds, dicyandiamide, borofluorides and octoate salts, and particularly preferred curing agents include aromatic amine-based curing agents, dicyandiamide and imidazole compounds. The above curing agents may be used either alone, or in combinations of two or more different materials.

The blend quantity of the component (C) is determined with due consideration of factors such as the blend quantity of the component (A), the epoxy equivalent weight of the component (B), and the cured state and balance of properties for the adhesive, and is typically set within a range from 0.1 to 30 parts by mass, preferably from 0.5 to 20 parts by mass, and even more preferably from 1 to 20 parts by mass, per 100 parts by mass of the component (A). If this blend quantity is less than 0.1 parts by mass, then satisfactory curing of the adhesive composition cannot be achieved, and the solder heat resistance and solvent resistance of the cured adhesive deteriorate, whereas if the quantity exceeds 30 parts by mass, the curing reaction of the adhesive composition proceeds overly vigorously, and the excess curing agent causes a deterioration in the adhesion and the solder heat resistance.

The curing agent of the component (C) may use either a single material, or if necessary, a combination of two or more different materials.

### [(D) Inorganic Filler]

Examples of the inorganic filler of the component (D) include metal hydroxides such as aluminum hydroxide and magnesium hydroxide, metal oxides such as aluminum oxide, silicon oxide and molybdenum oxide, and borate compounds such as zinc borate and magnesium borate. Preferred fillers include metal hydroxides such as aluminum hydroxide and magnesium hydroxide, and borate compounds such as zinc borate and magnesium borate, and particularly preferred fillers include aluminum hydroxide, magnesium hydroxide and zinc borate. These fillers may be used either alone, or in combinations of two or more different fillers.

These inorganic fillers are added for purposes such as assisting flame retardancy, improving the stability of the adhesive layer following removal of the releasable base material from the adhesive layer (in other words, ensuring a favorably aggregated adhesive layer following removal of the releasable base material), and stabilizing the moisture absorption properties. In order to improve the adhesion of these inorganic fillers to the resin matrix and improve the water resistance, the inorganic filler is preferably subjected to a hydrophobic treatment using a treatment agent such as a silane-based coupling agent or a titanate-based coupling agent. Conducting this hydrophobic treatment improves the adhesion of the inorganic filler to the resin, as well as improving the heat resistance and moisture absorption resistance of the resulting adhesive sheet.

The blend quantity of the component (D) is typically within a range from 10 to 60 parts by mass, preferably from 15 to 50 parts by mass, and even more preferably from 20 to 40 parts by mass, per 100 parts by mass of the combination of the components (A) through (C). If this blend quantity is less than 10 parts by mass, then the flame retardancy, release properties, solder properties and moisture absorption properties tend to deteriorate, whereas if the quantity exceeds 60 parts by mass, the solder properties and release properties deteriorate.

### [Other Optional Components]

Besides the components (A) through (D) described above, other optional components such as solvents, curing accelerators, flame retardants, coupling agents, antioxidants and ion adsorbents may also be added if required, provided they do not impair the properties of the adhesive sheet.

Examples of solvents that can be used in the adhesive composition of the present invention include methyl ethyl ketone (MEK), toluene, methanol, ethanol, isopropanol, acetone, N,N-dimethylformamide, cyclohexanone, N-methyl-2-pyrrolidone and dioxolane, and of these, MEK, toluene and N,N-dimethylformamide are preferred. These solvents may be used either alone, or in combinations of two or more different solvents.

In those cases where the adhesive composition is prepared as a solution by dissolving the components in a solvent, the solid fraction concentration of the solution is typically within a range from 20 to 60% by mass, and is preferably from 40 to 50% by mass. If the solid fraction concentration is less than 20% by mass, then irregularities in the thickness of the adhesive layer may occur during coating, whereas if the solid fraction concentration exceeds 60% by mass, the viscosity of the adhesive increases considerably, causing a worsening of the coating properties.

The solid components of the adhesive composition and the solvent may be mixed using a pot mill, ball mill, homogenizer or super mill or the like.

### <Adhesive Sheet>

The adhesive sheet of the present invention comprises a releasable base material, and a layer of an aforementioned adhesive composition provided on one surface of the base material. The releasable base material functions as a protective layer that covers the adhesive composition layer. There are no particular restrictions on the releasable base material, provided it is able to be peeled off the adhesive composition layer without damaging the state of the adhesive layer, and typical examples of suitable films include plastic films such as polyethylene (PE) films, polypropylene (PP) films, polymethylpentene (TPX) films and polyester films; and release sheets in which a polyolefin film such as a PE film or PP film, or a TPX film or the like is coated onto one side or both sides of a paper material.

Next is a description of a method of producing the adhesive sheet of the present invention.

An adhesive solution, prepared by adding an appropriate quantity of solvent to an already prepared composition described above, is applied to a releasable base material using a reverse roll coater or a comma coater or the like. The releasable base material with the applied adhesive composition is then passed through an in-line dryer, and heated at 80 to 160° C. for a period of 2 to 20 minutes, thereby removing the solvent from the adhesive and converting the adhesive composition to a semi-cured state. In this manner, an adhesive sheet with a two-layered structure is obtained. A separate release film is then attached to the adhesive composition side of this two-layered structure, and by subsequently conducting pressure bonding with heated rollers under conditions including a linear pressure of 0.2 to 20 kg/cm and a temperature of 40 to 120° C., an adhesive sheet with a three-layered structure is obtained. Examples of suitable materials for the release film include the same materials exemplified above for the releasable base material.

In an adhesive sheet of the present invention prepared in this manner, the thickness of the adhesive composition layer is within a range from 40 to 100 μm, and is preferably from 40 to 60 μm.

### EXAMPLES

As follows is a more detailed description of the present invention using a series of examples, although the present invention is in no way limited by the examples presented below.

### Examples 1 to 9

### Comparative Examples 1 to 6

### <Adhesive Composition Components>

In the examples and comparative examples, the following materials were used.

(A) Carboxyl Group-Containing Urethane-Modified Polyester Resin

Synthesis of the carboxyl group-containing urethane-modified polyester resin was conducted using known methods, by first synthesizing a polyester resin by a dehydration/esterification reaction between an acid and a polyol in the presence of a catalyst, adding an acid anhydride following completion of the reaction to form a carboxyl group-containing polyester resin, and subsequently reacting this carboxyl group-containing polyester resin with an organic diisocyanate in the presence of a catalyst.

In other words, using terephthalic acid and isophthalic acid as the acid component, ethylene glycol and neopentyl glycol as the polyol component, trimellitic anhydride as the acid anhydride component, and 1,6-hexamethylene diisocyanate as the organic diisocyanate component, and using appropriate blend quantities, the following carboxyl group-containing urethane-modified polyester resins (a), (b), (c) and (d) with different number average molecular weights were synthesized by normal methods. In the reaction between the acid and the polyol, and the reaction between the carboxyl group-containing polyester resin and the organic diisocyanate, suitable quantities of tetrabutyl titanate and dibutyltin dilaurate respectively were used as catalysts.

(1) Carboxyl group-containing urethane-modified polyester resin (a) (number average molecular weight: 4,500, carboxyl group content: 2.1%)
(2) Carboxyl group-containing urethane-modified polyester resin (b) (number average molecular weight: 9,000, carboxyl group content: 1.7%)
(3) Carboxyl group-containing urethane-modified polyester resin (c) (number average molecular weight: 16,000, carboxyl group content: 1.9%)
(4) Carboxyl group-containing urethane-modified polyester resin (d) (number average molecular weight: 43,000, carboxyl group content: 1.8%)

(B) Halogen-Free Epoxy Resin

(1) Epikote 834 (product name) (a bisphenol A epoxy resin, manufactured by Japan Epoxy Resins Co., Ltd., epoxy equivalent weight: approximately 250, molecular weight: approximately 700)
(2) Epikote 1001 (product name) (a bisphenol A epoxy resin, manufactured by Japan Epoxy Resins Co., Ltd., epoxy equivalent weight: approximately 480, molecular weight: approximately 900)
(3) Epikote 806 (product name) (a bisphenol F epoxy resin, manufactured by Japan Epoxy Resins Co., Ltd., epoxy equivalent weight: approximately 170)
(4) Epikote 604 (product name) (a glycidylamine tetrafunctional epoxy resin, manufactured by Japan Epoxy Resins Co., Ltd., epoxy equivalent weight: approximately 120)
(5) EOCN-103S (product name) (an ortho-cresol novolak polyfunctional epoxy resin, manufactured by Nippon Kayaku Co., Ltd., epoxy equivalent weight: approximately 220)
(6) FX-305 (product name) (a phosphorus-containing epoxy resin, manufactured by Tohto Kasei Co., Ltd., epoxy equivalent weight: approximately 500)

(C) Curing Agent

### (1) TPP (triphenylphosphine)

### (2) 2E4MZ-CN (product name) (1-cyanoethyl-2-ethyl-4-methylimidazole, manufactured by Shikoku Corporation)

(3) TMAB (product name: CUA4, trimethylene-bis(4-aminobenzoate))

### (4) Dicyandiamide

(D) Inorganic Filler

### (1) Higilite H43 STE (product name) (aluminum hydroxide filler, manufactured by Showa Denko K.K.)<

### <Preparation and Evaluation of Adhesive Sheets>

### Example 1

The components shown in Table 1 were mixed together in the proportions shown in the table (the units for the numerical values representing the blend proportions in Table 1 are “parts by mass”), and by adding a mixed solvent of methyl ethyl ketone and toluene (mixing ratio: 2/1) to the thus obtained mixture, a dispersion with a solid fraction concentration of 45% by mass was obtained. Subsequently, the dispersion was applied using an applicator to the surface of a polyester film (PET30x, manufactured by Lintec Corporation) of thickness 38 μm that had been coated with a release agent, with the application conducted in sufficient quantity to generate a dried adhesive composition layer with the thickness shown in Table 1, and the dispersion was then dried for 10 minutes at 120° C. in a forced air oven, thereby converting the composition to a semi-cured state and completing preparation of an adhesive sheet. The proportion (% by mass) of the inorganic filler (the component (D)) within the adhesive composition layer, relative to the combination of the resin components and the curing agent, was as shown in Table 1.

The properties of the adhesive sheet were evaluated using the methods described below. The results are shown in Table 1.

### Examples 2 to 9 and Comparative Examples 1 to 6

In each of these examples, with the exception of blending the materials shown in Table 1 and Table 2 in the proportions shown, adhesive sheets were prepared in essentially the same manner as the example 1. However, in the comparative examples 2, 3 and 4, when an adhesive dispersion was prepared with the same solid fraction concentration of 45% by mass used in the example 1, the resulting dispersion was extremely viscous, and because the adhesive dispersion was unable to be applied uniformly to the polyester film surface in a similar manner to the example 1, the solid fraction concentration of the adhesive dispersion was reduced to 35% by mass.

The properties of the thus obtained adhesive sheets were evaluated using the methods described below. The results are shown in Table 1 and Table 2.

### [Measurement Methods]

Number Average Molecular Weight

Measurement of the number average molecular weight was conducted using a gel permeation chromatograph HLC-8020 manufactured by Tosoh Corporation (column: TSKgel, GMH_{XL} manufactured by Tosoh Corporation), and was determined relative to polystyrene standards.

Film Surface Properties

The surface of an adhesive layer (i.e., a film of an adhesive) of each adhesive sheet prepared in the manner described above was inspected visually. In those cases where bubbles were noticeable at the film surface, the surface properties were evaluated as “poor”, and were recorded using the symbol x.

Peel Strength A

An adhesive layer from which the releasable base material (the polyester film) of an adhesive sheet had been removed was sandwiched between the polyimide film (electrically insulating film) surfaces of two flexible copper clad laminates (RAS22S47, manufactured by Shin-Etsu Chemical Co., Ltd.), and the resulting structure was then bonded together using a press apparatus (process conditions: 160° C.×3 MPa×70 minutes), yielding a measurement sample. This sample was cut into strips with a width of 10 mm, which were then used as test pieces. One of the flexible copper-clad laminates of the test piece was secured, and the minimum value for the force required to peel the other flexible copper-clad laminate at a speed of 50 mm/minute in a direction at an angle of 90 degrees relative to the secured flexible copper-clad laminate was then measured and recorded as the peel strength A.

Peel Strength B (Measured in Accordance with JIS C6481)

An adhesive layer from which the releasable base material (the polyester film) of an adhesive sheet had been removed was sandwiched between a polyimide film (Kapton 100H, manufactured by Toray-DuPont Co., Ltd., film thickness: 25 μm) and the glossy surface of an electrolytic copper foil (manufactured by Japan Energy Corporation, thickness: 35 μm), and the resulting structure was then bonded together using a press apparatus (process conditions: 160° C.×3 MPa×70 minutes), yielding a measurement sample. This sample was cut into strips with a width of 10 mm, which were then used as test pieces. The polyimide film of the test piece was secured, and the minimum value for the force required to peel the copper foil at a speed of 50 mm/minute in a direction at an angle of 90 degrees relative to the polyimide film was then measured and recorded as the peel strength B.

Solder Heat Resistance (Following Moisture Absorption) (Measured in Accordance with JIS C6481)

A measurement sample prepared for the measurement of the aforementioned peel strength B was cut into 25 mm squares to form test pieces. These test pieces were then left to stand for 24 hours in an atmosphere of 40° C. and 90% RH, and were then floated for 30 seconds on a solder bath of constant temperature. The temperature of the solder bath was varied, and additional float tests conducted, and the maximum temperature for which no blistering or discoloration of the test piece occurred was measured and recorded.

Anti-Migration Properties

An adhesive layer separated from the protective layer of an adhesive sheet was sandwiched between a polyimide film (Kapton 100H, manufactured by Toray-DuPont Co., Ltd., film thickness: 25 μm), and a two-layered flexible copper-clad laminate manufactured by Shin-Etsu Chemical Co., Ltd. (Tradename: KN28SR18A) in which the copper foil thereof had been etched to form a comb-shaped circuit formed of a pair of comb-shaped electrodes and having a pitch of 160 μm (line/space=80/80 μm). The resulting structure was then bonded together using a press apparatus (process conditions: 160° C.×3 MPa×70 minutes), yielding an evaluation sample. Under conditions including a temperature of 85° C. and a relative humidity of 85%, a voltage of 50 V was applied across the terminal of each of the two comb-shaped electrodes using a migration tester (product name: MIG-96, manufactured by IMV Corporation). Those samples for which the resistance was at least 100 MΩ after 1,000 hours were evaluated as “good”, and were recorded using the symbol “O”, whereas those samples for which the resistance had fallen to less than 100 MΩ were evaluated as “poor” and were recorded using the symbol “x”.

Evaluation of Bonding Properties Between Copper Circuit Printed Surfaces of Flexible Copper-Clad Laminates

An adhesive sheet prepared in the example 2 was evaluated. An adhesive layer separated from the protective layer of the adhesive sheet was sandwiched between the circuit surfaces of two flexible copper-clad laminates (product name: KN28SR18A) with comb-shaped circuits as formed in the evaluation of the anti-migration properties in such a way that the positive electrode and the negative electrode of one of the pairs of the comb-shaped electrodes are arranged face to face with the negative electrode and the positive electrode of the other, respectively. The resulting structure was then subjected to thermocompression bonding using a press apparatus (process conditions: 160° C.×3 MPa×70 minutes), yielding an evaluation sample. For the sample thus prepared, the resistance between the two comb-shaped electrodes facing each other through the adhesive layer was measured under normal conditions. If the resistance value was at least 10¹²Ω, then internal short-circuits between the electrodes were deemed not to occur, and the structure was evaluated as “passed” and was recorded using the symbol “O”, whereas if the resistance was less than 10¹²Ω, then internal short-circuits between the comb-shaped electrodes were deemed to have occurred, and the structure was evaluated as “failed” and was recorded using the symbol “x”.

For comparison, an adhesive sheet prepared in the comparative example 4 was evaluated in the same manner as described for the adhesive sheet of the example 2.

TABLE 1

| | | Example | | | | | | | | |
|---|---|---|---|---|---|---|---|---|---|---|
| Adhesive composition | | 1 | 2 | 3 | 4 | 5 | 6 | 7 | 8 | 9 |
| (A) Carboxyl group- | Resin (a) (Mn: 4,500) | — | — | — | — | — | — | — | — | — |
| containing urethane- | Resin (b) (Mn: 9,000) | 100 | 100 | 100 | 100 | — | — | — | — | 100 |
| modified polyester | Resin (c) (Mn: 16,000) | — | — | — | — | 100 | 100 | 100 | 100 | — |
| resin | Resin (d) (Mn: 43,000) | — | — | — | — | — | — | — | — | — |
| (parts by mass) | | | | | | | | | | |
| (A′) NBR resin | Nipol 1072B | — | — | — | — | — | — | — | — | — |
| (parts by mass) | | | | | | | | | | |
| (B) Epoxy resin | FX-305 | — | — | — | — | — | — | 15 | — | — |
| (parts by mass) | Epikote 604 | — | — | — | — | 10 | — | — | — | — |
| | Epikote 806 | — | — | — | — | — | — | — | 15 | — |
| | Epikote 834 | 10 | 5 | 10 | 15 | — | 10 | — | — | 10 |
| | Epikote 1001 | — | 5 | — | — | — | — | — | — | — |
| | EOCN-103S | 15 | 15 | 15 | 10 | 15 | 15 | 10 | 10 | 15 |
| (C) Curing agent | TMAB | — | — | — | — | — | — | 5 | — | — |
| (parts by mass) | Dicyandiamide | — | — | — | — | — | — | — | 5 | — |
| | TPP | 0.5 | — | — | 0.5 | — | 0.5 | 0.2 | — | 0.5 |
| | 2E4MZ-CN | — | 0.5 | 0.5 | — | 0.5 | — | — | 0.2 | — |
| (D) Inorganic filler | H43STE | 40 | 40 | 50 | 50 | 40 | 40 | 40 | 40 | 40 |
| (parts by mass) | | | | | | | | | | |
| Adhesive composition | μm | 50 | 50 | 50 | 50 | 50 | 50 | 50 | 50 | 100 |
| thickness | | | | | | | | | | |
| Inorganic filler ratio | % by mass | 31.9 | 31.9 | 39.8 | 39.8 | 31.9 | 31.9 | 30.7 | 30.7 | 31.9 |
| Film surface | — | ◯ | ◯ | ◯ | ◯ | ◯ | ◯ | ◯ | ◯ | ◯ |
| properties | | | | | | | | | | |
| Peels strength A | N/cm | 36 | 35 | 36 | 35 | 33 | 34 | 33 | 35 | 38 |
| Peel strength B | N/cm | 16 | 16 | 15 | 15 | 14 | 14 | 14 | 13 | 19 |
| Solder heat resistance | ° C. | 270 | 270 | 270 | 270 | 270 | 270 | 270 | 270 | 270 |
| (moisture absorption) | | | | | | | | | | |
| Anti-migration | At least 100 MΩ | ◯ | ◯ | ◯ | ◯ | ◯ | ◯ | ◯ | ◯ | ◯ |
| properties | | | | | | | | | | |

| | | | | | | | | | |
|---|---|---|---|---|---|---|---|---|---|
| Bonding properties between copper circuit | — | ◯ | — | — | — | — | — | — | — |
| printed surfaces | | | | | | | | | |

TABLE 2

| | | Comparative Example | | | | | |
|---|---|---|---|---|---|---|---|
| Adhesive composition | | 1 | 2 | 3 | 4 | 5 | 6 |
| (A) Carboxyl group- | Resin (a) (Mn: 4,500) | 100 | — | — | — | — | — |
| containing urethane- | Resin (b) (Mn: 9,000) | — | — | — | 100 | 100 | 100 |
| modified polyester | Resin (c) (Mn: 16,000) | — | — | — | — | — | — |
| resin | Resin (d) (Mn: 43,000) | — | 100 | — | — | — | — |
| (parts by mass) | | | | | | | |
| (A′) NBR resin | Nipol 1072B | — | — | 100 | — | — | — |
| (parts by mass) | | | | | | | |
| (B) Epoxy resin | FX-305 | — | — | — | — | — | — |
| (parts by mass) | Epikote 604 | — | — | — | — | — | — |
| | Epikote 806 | — | — | — | — | — | — |
| | Epikote 834 | 10 | 10 | 10 | 5 | 5 | 10 |
| | Epikote 1001 | — | — | — | 5 | 5 | — |
| | EOCN-103S | 15 | 15 | 15 | 15 | 15 | 15 |
| (C) Curing agent | TMAB | — | — | — | — | — | — |
| (parts by mass) | Dicyandiamide | — | — | — | — | — | — |
| | TPP | 0.5 | 0.5 | 0.5 | — | — | 0.5 |
| | 2E4MZ-CN | — | — | — | 0.5 | 0.5 | — |
| (D) Inorganic filler | H43STE | 40 | 40 | 40 | 5 | 200 | 40 |
| (parts by mass) | | | | | | | |
| Adhesive composition | μm | 50 | 50 | 50 | 50 | 50 | 120 |
| thickness | | | | | | | |
| Inorganic filler ratio | % by mass | 31.9 | 31.9 | 31.9 | 4.0 | 159.4 | 31.9 |
| Film surface | — | ◯ | X | X | X | X | X |
| properties | | | | | | | |
| Peels strength A | N/cm | 7 | 33 | 12 | 5 | 3 | 37 |
| Peel strength B | N/cm | 5 | 13 | 11 | 5 | 4 | 17 |
| Solder heat resistance | ° C. | 220 | 260 | 260 | 230 | 240 | 260 |
| (moisture absorption) | | | | | | | |
| Anti-migration | At least 100 MΩ | ◯ | ◯ | X | ◯ | X | ◯ |
| properties | | | | | | | |

| | | | | | | |
|---|---|---|---|---|---|---|
| Bonding properties between copper circuit | — | — | — | X | — | — |
| printed surfaces | | | | | | |

### <Evaluation Results>

The adhesive compositions used in the examples 1 to 9 satisfy the requirements of the present invention, and the adhesive sheets comprising these adhesive compositions exhibited excellent peel strength, solder heat resistance and anti-migration properties. Furthermore, the results of evaluating the bonding between copper circuit printed surfaces of flexible copper-clad laminates revealed that when the adhesive sheet of the example 2 was used, the interline (that is, between adjacent teeth of the comb) insulation resistance of the comb-shaped electrodes was in the order of 10¹²Ω, meaning no internal short-circuits between circuits were observed. In contrast, because the adhesive sheet of the comparative example 1 used a carboxyl group-containing urethane-modified polyester resin with a molecular weight of 4,500 as the principal component of the adhesive composition, the peel strength and solder heat resistance decreased.

Furthermore, because the adhesive sheet of the comparative example 2 used a carboxyl group-containing urethane-modified polyester resin with a molecular weight of 43,000 as the principal component of the adhesive composition, when an adhesive dispersion was prepared with the same solid fraction concentration of 45% by mass used in the examples, the resulting adhesive dispersion was very viscous, and application was impossible. As a result, the solid fraction concentration needed to be reduced to 35% by mass. Consequently, the quantity of organic solvent that needed to be volatilized during drying increased, which generated a large quantity of bubbles within the dried adhesive film, resulting in a x evaluation for the film surface properties.

In the comparative example 3, because NBR was used as the component (A) instead of a carboxyl group-containing urethane-modified polyester resin, the anti-migration properties of the resulting adhesive sheet deteriorated significantly. Furthermore, for the same reason as that described for the comparative example 1, the solid fraction concentration needed to be reduced to 35% by mass, resulting in a x evaluation for the film surface properties of the obtained adhesive sheet.

In the comparative example 4, because the quantity of the inorganic filler was less than the range specified in the present invention, when an adhesive dispersion was prepared with the same solid fraction concentration of 45% by mass used in the examples, the resulting adhesive dispersion was very viscous, and the solid fraction concentration needed to be reduced to 35% by mass. As a result, in a similar manner to the comparative examples 2 and 3, bubbles and unevenness were generated within the surface of the adhesive layer obtained upon application and drying of the adhesive dispersion, making the film surface properties unsatisfactory.

Furthermore, the results of evaluating the bonding properties between the copper circuit printed surfaces of flexible copper-clad laminates revealed an interline insulation resistance for the comb-shaped electrodes in the order of 10¹⁰Ω, confirming the occurrence of partial internal short-circuits. In the comparative example 4, it is thought that this observation is because the thickness of the adhesive sheet was uneven, and that the existence of a multitude of defects within the adhesive film due to air bubbles caused the occurrence of minor but partial internal short-circuits.

In the comparative example 5, because the blend quantity of the inorganic filler of the component (E) is very large at 159.4% by mass, the peel strength of the resulting adhesive sheet deteriorated dramatically. Furthermore, the anti-migration properties also deteriorated.

In the comparative example 6, because the thickness of the adhesive composition was set to 120 μm, the organic solvent was not able to be satisfactorily volatilized from the interior of the adhesive composition during the drying step, resulting in the generation of a large quantity of bubbles within the adhesive film following drying, and coating irregularities were also evident, resulting in a x evaluation for the film surface properties.

### INDUSTRIAL APPLICABILITY

The adhesive sheet of the present invention exhibits excellent adhesion and insulation reliability (anti-migration properties), has a thickness for the adhesive layer of 40 to 100 μm that exceeds the thickness of conventional sheets, and yet still exhibits favorable uniformity with no bubbles or unevenness. Accordingly, the adhesive sheet is expected to be useful as an interlayer insulating material within new mounting techniques.

What is claimed is:

1. An adhesive sheet comprising a releasable base material, and an adhesive layer formed on one surface of the base material, wherein
the adhesive layer comprises an adhesive composition comprising:
(A) 100 parts by mass of a carboxyl group-containing urethane-modified polyester resin,
(B) 5 to 100 parts by mass of an epoxy resin,
(C) 0.1 to 30 parts by mass of a curing agent, and
(D) 10 to 60 parts by mass of an inorganic filler per 100 parts by mass of a combination of components (A) through (C),
and has a thickness within a range from 40 to 100 μm.

2. The adhesive sheet according to claim 1, wherein the number average molecular weight of the carboxyl group-containing urethane-modified polyester resin of the component (A) is within a range from 8,000 to 40,000.

3. The adhesive sheet according to claim 1, wherein the quantity of carboxyl groups contained within the carboxyl group-containing urethane-modified polyester resin of the component (A) is within a range from 0.4 to 8.0% by mass.

4. The adhesive sheet according to claim 1, wherein the epoxy resin of the component (B) contains two or more epoxy groups per molecule.

5. The adhesive sheet according to claim 1, wherein the epoxy resin of the component (B) comprises a bisphenol A epoxy resin, bisphenol F epoxy resin, stilbene epoxy resin, biphenyl epoxy resin, alicyclic epoxy resin, phenoxy resin, phenol novolak epoxy resin, cresol novolak epoxy resin, glycidylamine epoxy resin, or polyphenylmethane epoxy resin.

6. The adhesive sheet according to claim 1, wherein the curing agent of the component (C) comprises an aliphatic amine-based curing agent, an alicyclic amine-based curing agent, an aromatic amine-based curing agent, an acid anhydride-based curing agent, an imidazole compound, dicyandiamide, a borofluoride, or an octoate salt.

7. The adhesive sheet according to claim 1, wherein the inorganic filler of the component (D) comprises aluminum hydroxide, magnesium hydroxide, aluminum oxide, silicon oxide, molybdenum oxide, zinc borate, or magnesium borate.

8. The adhesive sheet according to claim 1, wherein the composition further comprises at least one solvent to form a solution, and the solid fraction concentration of the solution is within a range from 20 to 60% by mass.
